(19) United States
(12) Patent Application Publication
(10) Pub. No.: US 2004/0256753 A1
(43) Pub. Date: Dec. 23, 2004

(54) Controlling injection moulding processes

(76) Inventor: John Lamberton, Norfolk (GB)

Correspondence Address: BRUCE E. LILLING, LILLING & LILLING P.C., P.O. BOX 560, GOLDEN BRIDGE, NY, 10526, US

(21) Appl. No.: 10/493,738

(22) PCT Filed: Oct. 24, 2002
(86) PCT No.: PCT/GB02/04840

(30) Foreign Application Priority Data
Oct. 25, 2001 (GB) 0125597.5

(51) Int. Cl. B29C 45/76; B29C 45/78

(52) U.S. Cl. 264/40.1; 264/40.6; 264/328.15; 425/144; 425/549

(57) ABSTRACT

Apparatus for controlling the operation of an injection moulding or extrusion tool comprises in this specific case of an injection moulding machine: means for measuring and displaying the numerical values of the temperature at the or each injection nozzles location at any given time; means for measuring and displaying the numerical values of the electrical power consumption of the or each mould cavity at any given time; means for controlling the temperature of the or each mould and/or the or each platen and/or the or each manifold and/or the or each seal of the tool in response to variations in the magnitude or rate of change of the electrical power consumption of the or each mould cavity.

### FIELD OF THE INVENTION

The invention relates to apparatus and processes for controlling injection moulding or extrusion tools.

Review of Art Known to the Applicants

Large-scale continuous-production injection moulding tools are well known as a class and are expensive, complex, and heavily used pieces of machinery that need continuous temperature monitoring and maintenance in use. Any down time caused by interruption of the production process from such a machine can be inordinately expensive. Equally if not more expensive are the consequences of any damage to the injection moulding tool itself

The problems caused by undetected deviations from the norm in commercial scale injection moulding tool operation cannot be exaggerated. They include:

The inadvertent production of defective products which go undetected for too long.

The risk of partial blockage of the injecting nozzle by insufficient plasticised product which can distort the temperature and power consumption profile of the individual nozzle as well as, again, producing defective individual products thereafter until detected.

Unacceptable variations in sizing and dimensions generally of individual products caused by temperature variations within the tool which go undetected because any one or more nozzles is not operating at predetermined optima.

Damage to the large-size electrical heaters used to heat the nozzles and being caused by failure to detect a sudden and/or prolonged rise in tool temperature.

Warpage of the mould tool.

In the ultimate, having to scrap the tool itself.

In any individual one or any combination of these instances the downtime which will result is almost always unacceptable and expensive given the rates of production of these machines in commercial usage.

The typical injection moulding tool supplying individual plastics products may incorporate anything from 1-200 individual moulding nozzles to produce simultaneously a corresponding number of plastics articles at each closing of the tool moulding platen against its co-operating manifold. The pressures and plasticising temperatures at which these tools operate are such that, whilst it is necessary to keep the bulk of the tool relatively cool throughout the moulding cycle, the nozzles themselves will be operating at plasticising temperatures of between 200-250 degrees C.

There is thus an inherent contradiction between the one requirement and the other in this context.

Conventionally the tool platen will be liquid-cooled, for example by using cooled chilled water circulating around it and within it, and temperature-sensing thermo couples in conjunction with flow rate monitoring water meters will be linked to visually displayed graphics in order to monitor, and balance, the fluctuations in measured temperature.

The drawbacks of these are that, firstly, the temperature monitoring thermo couple outside and around the tool are susceptible to breaking down in the relatively harsh environment of heat, movement, and vibration in which these large-scale tools operate; and secondly, any form of water-immersed flow meter or water temperature sensing the couple tends to fur up relatively quickly in the long shift cycles under which these machines are typically run.

The invention in any of its embodiments enables this and other problems to be overcome or at the very least to be reduced to a tangible extent in comparison with known apparatus and methods.

### SUMMARY OF THE INVENTION

The invention takes a different approach in that, instead of trying to monitor the temperature at different parts of the tool, and/or monitoring satisfactorily the temperature or rate of cooling around and through the platen, it monitors and controls the rate at which the power consumption within the tool is changing as the tool operates.

A small change in tool nozzle temperature can cause a relatively large change in power consumption. If the temperature rises unacceptably when heat is not being removed at a fast enough rate from the tool (e.g. when the water flow has temporarily just failed) then the electrical power being consumed at the nozzle will drop to an immediately noticeable extent. If this is monitored and appropriately displayed then remedial action can be taken before sustainable damage occurs and consequently unacceptable production downtime can be avoided or at any rate minimised.

Apparatus incorporating the means to do this can be self-contained and can be plugged in as a diagnostic tool to individual injection moulding machine lines or controller. It doesn't need permanent incorporation into the machine as such. It can be so configured as to display all the individually monitored nozzle data alongside one another and the circuitry and components needed to do this will be within the skill of the intended addressee of this specification without the need for inventive thought.

In one broad aspect the invention provides apparatus for controlling the operation of an injection moulding or an extrusion tool, comprising in the specific case of an injection moulding machine:

means for measuring and displaying the numerical values of the temperature at the or each injection nozzle's location at any given time,

means for measuring and displaying the numerical values of the electrical power consumption of the or each mould cavity at any given time,

means for controlling the temperature of the or each mould and/or the or each platen and/or the or each manifold and/or the or each seal of the tool in response to variations in the magnitude of the electrical power consumption of the or each mould cavity.

This configuration is particularly advantageous because it departs from conventional systems which would simply react to temperature values and coolant conditions. It addresses more directly the causes of tool damage and identifies means to reduce the time between detection of abnormal tool operation and its correction. Significantly reducing this detection time and remedial time will advantageously limit the occurrence of the problems caused by undetected deviations from the norm which were detailed in the above review of art known to the applicants.

In another broad aspect the invention provides a process for controlling the operation of an injection moulding or an extrusion tool, comprising in the specific case of an injection moulding machine the steps of:

measuring and displaying the numerical value of the temperature at the or each injection nozzle's location at any given time,

measuring and displaying the numerical value of the electrical power consumption of the or each mould cavity at any given time,

controlling the temperature of the or each mould and/or the or each platen and/or the or each manifold and/or the or each seal in response to variations in the electrical power consumption at any given time.

### PUTTING THE INVENTION INTO PRACTISE

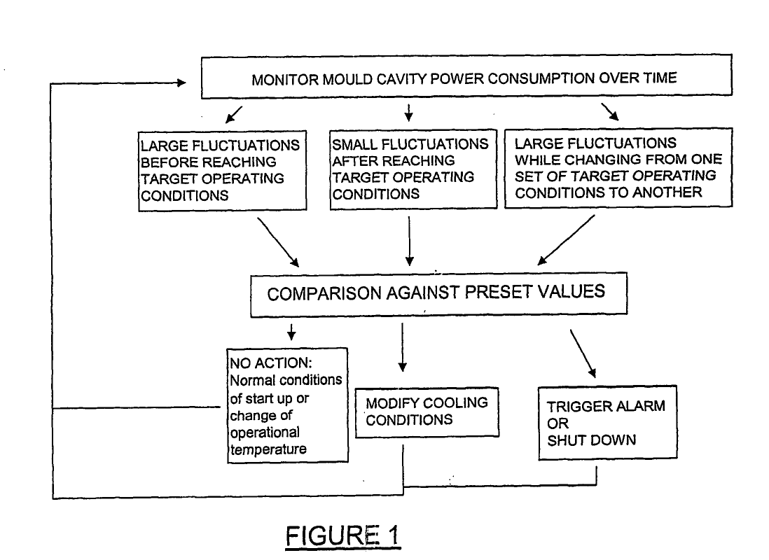

A single figure (FIG. 1) presents an exemplary embodiment of a control means in the form of a flow chart. This FIGURE illustrates the invention in the injection moulding field. The control means monitors the operation of the tool during its entire running cycle. At different time points and at regular intervals the control means obtains values of power consumption for a particular mould cavity. It may be particularly beneficial to obtain cavity specific information as the operating conditions of one cavity may vary substantially from the operating conditions of another cavity.

The control means will incorporate a comparator which will be programmed with a set of pre-determined values typical of the tool in question and its particular operating conditions.

During either the initial start up of the tool or its change of operational temperature the power consumption over time may experience large fluctuations before reaching the tools target operating conditions. The comparator will take these various parameters into consideration and instruct no action as these large fluctuations are typical of a tool during either start up or while changing operational temperature.

Once the tool has reached its target operating conditions, small fluctuations of power consumption may be identified by the control means and a comparison against pre-set values would have remedial consequences. When these small fluctuations are typical of an increase in temperature, instructions to increase or otherwise modify the cooling conditions of the tool may be issued by the control means. This remedial process will then be closely monitored by the control means over time and rectified to take into account any further modifications of the operating conditions resulting from previous actions triggered by the control means.

When the power consumption values fall outside a pre-determined range of values, the control means may, in certain instances, trigger an alarm, for example, during the daytime where maintenance is close at hand or even instruct the shutdown of the tool if such maintenance is not available, such as, outside working hours.

As mentioned above, once the inventive concept has been understood, the skilled reader will be able to select from known alternatives those electronic and other components and circuitry or software which will enable the invention to be reduced to practical form.

Whilst chilled cooling water conventionally circulates in both the fixed (manifold) and moving (platten) halves of the injection moulding tool, it is currently preferred to monitor only the individual nozzle temperatures, and not to incorporate into the monitored statistics any influencing factor by way of temperature within the manifold. Whilst the latter can of course be displayed they do not form any essential feature of the presently preferred control means and mechanism on which the invention is centred.

Automatic or individually judged override and/or shutdown facilities can be incorporated into any apparatus embodying the invention. For example if power consumed were to go inside or outside a predetermined band, or if the same variable were to depart by more than a predetermined amount either way from a preset value for a given individual injection nozzle.

Displaying the power consumed as a percentage of normal full power consumption requirement would be one convenient way of embodying the invention in practise.

In this specification, the term “power” is used broadly, not specifically. In other words, electrical current, amperage and electrical voltage, are possible meanings as well as electrical wattage.

Although described specifically in relation to water-cooled, electrically-heated injection moulding machines, the invention in its broadest aspects is applicable to machines using other forms of heating and/or cooling—as apparent from the claims which now follow.

The invention extends ultimately to any process for controlling the operation of machinery requiring precise control of temperature and operating parameters where the monitoring of power or its components will provide automatic shut down.

1. Apparatus for controlling the operation of an injection moulding tool, comprising:
means for measuring the numerical values of the temperature from at least one injection nozzle's location at any given time,
means for measuring the numerical values of the electrical power consumption of at least one mould cavity at any given time,
means for evaluating during the operation of the tool variations in values of the electrical power consumption against pre-determined acceptable electrical power consumption values for any particular operative mode of a tool; and
means for controlling operative parameters of the tool in response to said evaluation by at least one action selected from the group comprising: continuing the operation of the tool because the values are evaluated as acceptable, shutting down the injection moulding process because the values are evaluated as not acceptable and modifying the cooling conditions because the values are evaluated as not acceptable, whereby any loss of cooling medium in the tool may be monitored.

2. Apparatus according to claim 1, where said means for controlling operative parameters of the tool are idle during a predetermined start up period.

3. Apparatus according to claim 1, wherein means evaluate the rate of change of electrical power.

4. Apparatus according to claim 2, wherein means evaluate the rate of change of electrical power.

5. Process for controlling the operation of an injection moulding tool, comprising the steps of:
measuring the numerical values of the temperature from at least one injection nozzle's location at any given time;
measuring the numerical values of the electrical power consumption of at least one mould cavity at any given time,
evaluating during the operation of the tool variations in values of the electrical power consumption against pre-determined acceptable electrical power consumption values for any particular operative mode; and
controlling operative parameters of the tool in response to said evaluation by initiating at least one action selected from the group of actions comprising: continuing the operation of the tool because the values are evaluated as acceptable, shutting down the injection moulding process because the values are evaluated as not acceptable and modifying the cooling conditions because the values are evaluated as not acceptable, whereby any loss of cooling medium in the tool may be monitored.
